(19) United States
(12) Patent Application Publication
(10) Pub. No.: US 2025/0181387 A1
(43) Pub. Date: Jun. 5, 2025

(54) NESTED PARALLEL COPY OF ENTITIES DURING DATA MIGRATION

(71) Applicant: SAP SE, Walldorf (DE)

(72) Inventor: Stoyan Zhivkov Boshev, Sofia (BG)

(21) Appl. No.: 18/526,237

(22) Filed: Dec. 1, 2023

(51) Int. Cl. G06F 9/48

(52) U.S. Cl. CPC G06F 9/4881; G06F 2209/5011

(57) ABSTRACT

The present disclosure relates to computer-implemented methods, software, and systems for data migration between data sources by applying nested parallel copying mechanism. A request to copy a source directory to a target directory is received. Entities included in the source directory are identified. Data migration is executed from the source directory to the target directory by performing: assigning a thread pool executor that is configured to execute copy operations at at least one of multiple threads executed by the thread pool executor, where a new copy job is to be executed for migrating content of a respective entity from the source directory to the target directory; and in response to determining that there is no available-for-execution thread at the thread pool executor, copying the respective entity as a nested copy in a currently executing thread that is executing a current copy job.

### TECHNICAL FIELD

The present disclosure relates to computer-implemented methods, software, and systems for data processing and data migration.

### BACKGROUND

Software applications and application services may include front-end and back-end applications and application logic that is executed to provide functionality and serve requests from end-users. When an application or application service is running, they can consume resources from a data source in relation to execution of operations, such as a read operation, a write operation, and an edit operation, among others. In some cases, data from one data source can be migrated to another data source. Such data migration is associated with a lot of computation resources and may be time consuming when the migration entails a huge number of files and/or directories.

### SUMMARY

The present disclosure involves systems, software, and computer implemented methods for data migration between data sources by applying nested parallel copying mechanism.

One example method may include operations such as: obtaining a request to copy a source directory to a target directory; identifying entities included in the source directory; and executing data migration from the source directory to the target directory by performing, for each identified entity: assigning a thread pool executor that is configured to execute copy operations at at least one of multiple threads executed by the thread pool executor, wherein a new copy job is to be executed for migrating content of a respective entity from the source directory to the target directory; and in response to determining that there is no available-for-execution thread at the thread pool executor, copying the respective entity as a nested copy in a currently executing thread that is executing a current copy job.

In some instances, the entities may include a first set of files and a second set of directories. In some instance, the method can include that, for each identified entity and in response to determining, by the currently executing thread at the thread pool executor, that there is an available-for-execution thread at the thread pool executor, a new scheduled copy job is provided to copy the respective entity through the available-for-execution thread at the thread pool executor.

In some instances, the request to copy can be received from an application that requests execution of the data migration of data from the source directory to the target directory. In some instances, during the data migration, the application can be denied write access to data from at least one of the source directory or the target directory for processing service requests received at the application. In some instances, the thread pool executor can be configured to include a plurality of threads for parallel job execution. A number of the plurality of threads is adjustable during the data migration execution based on thread optimization rules.

In some instances, the method can include that: in response to performing scheduled checks of performance of the data migration, a performance score is determined at each scheduled check defining a number of executed copy operations with a predefined time period. In response to determining a change in the performance score over a threshold time for executing the scheduled checks, a number of threads allocated for parallel processing at the thread pool executor can be auto-tuned.

In some instances, the determination that there is no available-for-execution thread is performed by the currently executing thread upon finishing of the current copy job and while the current executing thread is running.

Similar operations and processes may be performed in a system including at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. In other words, while generally described as computer-implemented software embodied on tangible, non-transitory media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example computer system architecture that can be used to execute implementations of the present disclosure.

FIG. 2 is a flowchart for an example method for executing data migration between a source directory and a target directory in accordance with implementations of the present disclosure.

FIG. 3 is a block diagram for an example method for data migration between a source directory and a target directory in accordance with implementations of the present disclosure.

FIGS. 4 and 5 are flowcharts for an example method for data migration between a source directory and a target directory in accordance with implementations of the present disclosure.

FIG. 6 is a schematic illustration of example computer systems that can be used to execute implementations of the present disclosure.

### DETAILED DESCRIPTION

The present disclosure describes various tools and techniques for data migration between directories by applying a nested parallel copying mechanism.

In some instances, when an application is running and executing process logic to provide services to users and/or other instances (e.g., applications or services), the application can access files or data entities stored in a data storage. In some instances, the data stored at the data storage may be migrated from one storage to another. Examples of such migrations can include cases where a new data source instance is to be used for persisting the data, performing a backup, or integrating multiple data sources into a single data source, among other examples. While data is migrated from one data volume to another, the application may not have access to the data, potentially causing downtime of the services when they require data from the storage.

In some instances, data migration between data volumes (e.g., directories) can be performed by using multiple thread techniques that can be applied when copying the data from one directory to another, and nesting execution of new tasks in existing running threads. In some instances, the directories storing the data can be hard disks such as SSD disks, or can be network data volumes hosted on virtual machines on the cloud. In some instances, such migration can be used when migrating the source directory as a whole, for example, with an initial data replication for generating a backup copy. In some instances, the migration can be performed when performing a delta copy for the modified files and/or directories since a previous copy operation (e.g., a full replication or a previous delta copy). In some instances, the migration can be performed for a determined or selected set of files from the source directory to be replicated to a target directory that fulfill a copy criterion (e.g., after applying a filtering criterion). In some instances, the copy criterion can include, for example, copying files that are modified by a particular user, a list of files and/or directories selected for copying, a list users associated with the files (e.g., owners of the file), a type of file (e.g., only metadata files), a rule for evaluating the source directory to select a subset of the files or directories (e.g., a rule defining one or multiple criteria such as the presented examples), and other suitable criterion.

In accordance with the present implementations, a tool service can be provided that supports execution of copy operations to migrate content from a source directory to a target directory. In some instances, the tool service can be connected with an application that uses data from the source directory, for example, to provide services to end users of the application. In some instances, the target directory can be used as a backup storage or as a new directory to be connected with the application for further use. The application can be a cloud application, a native application, or a web application, among other example applications. In some instances, the tool service can provide logic to execute the data migration by implementing a thread pool executor where scheduled jobs for copying content, such as files and/or directories, from the source directory can be executed over multiple threads in a parallel manner. The thread pool executor can provide resources for executing jobs over multiple threads where the number of threads can be dynamically determined and adjusted so that the number of threads that are utilized supports improved performance. For example, if there are too many threads that work in parallel, the performance of the execution as a whole may be reduced because of the multiple thread context switching. In some cases, the number of threads to be used during migration can be maintained, and, when the current threads are unavailable to execute more jobs, a currently executing thread can be reused to execute a next job fed into the thread pool executor. In some instances, the algorithm that can be used for the parallel copy operation execution for files and directories from the source directory can configure the thread pool executor to reuse, as much as possible, each thread from the pool that is already assigned with a copy job, allowing that thread to continue copying files or directories when there are no free threads in the thread pool. In some instances, if a running thread, after executing a current copy job, determines that there are free threads in the thread pool, then the thread pool executor can route a new job to copy the next file or directory and continue with the rest of the files/directories.

In some instances, the number of the threads can also be evaluated according to a current determined performance of the copy operation (including evaluating the performance of the copy operations performed by the multiple threads that have been used for executing multiple jobs), thus allowing the solution to auto-tune the number of threads to improve the overall performance. This auto-tuning feature is performed based on performance metrics evaluated for the performance of copy operations for files and/or directories from a source directory to a target directory, where the number of threads can be adjusted (i.e., either increased or decreased) during the time the copy operations are performed and before executing the complete copy of the source directory to the target directory. In some instances, the tool can regularly check the performance within a predefined period (e.g., a number of seconds, minutes, a number of operations performed, or other) and, if the performance has increased, the tool may increase the number of threads performing copy operations in parallel. If the performance has declined, the tool may reduce the number of threads. In some instances, the performance metrics can be determined as the number of processed files/directories per second and/or the number of bytes copied per second. In some instances, the tool may also use other metrics to determine the performance load of the system, such as for example, CPU load, Disk load, etc. The performance metrics can be directly measured by the tool and/or obtained from an external entity performing the measurements. Upon obtaining the performance metrics and determining that the performance metrics meet a criterion to perform adjustment to the number of threads, an auto-tuning of the number of the treads used for the parallel execution of a copy job can be executed, and the number of the threads can be adjusted. In some examples, the criterion can define a threshold performance metric that can be used to compare with the measured performance and used as a reference point as to how to adjust the number of threads. For example, if the performance metric is the number of processed files and/or directories for a given time period, the threshold value is 40, and the performance metric is determined to be 50, then the performance metric for the current execution exceeds the threshold and the number of threads can be reduced.

In some instances, the tool service can include logic to perform synchronization operations when performing the data migration from the source directory to the target directory. For example, before scheduling a copy job for execution of a copy operation of a file or directory by a thread from the thread pool to the target directory, a check can be performed to determine whether the file and/or directory to be copied already exists in the target directory, and, if so, whether the file in the target directory has the same attributes as the one from the source directory. In some instances, attributes of the files and/or directories that can be evaluated can include a checksum that is generated based on the content of the file (e.g., a unique number generated based on the file that can be used to determine whether the two files have the same content), user(s) associated with the file (e.g., whether the file has the same owner), or other attributes that may be evaluated as a single criterion or as a combination of attributes to be evaluated as a combined criteria.

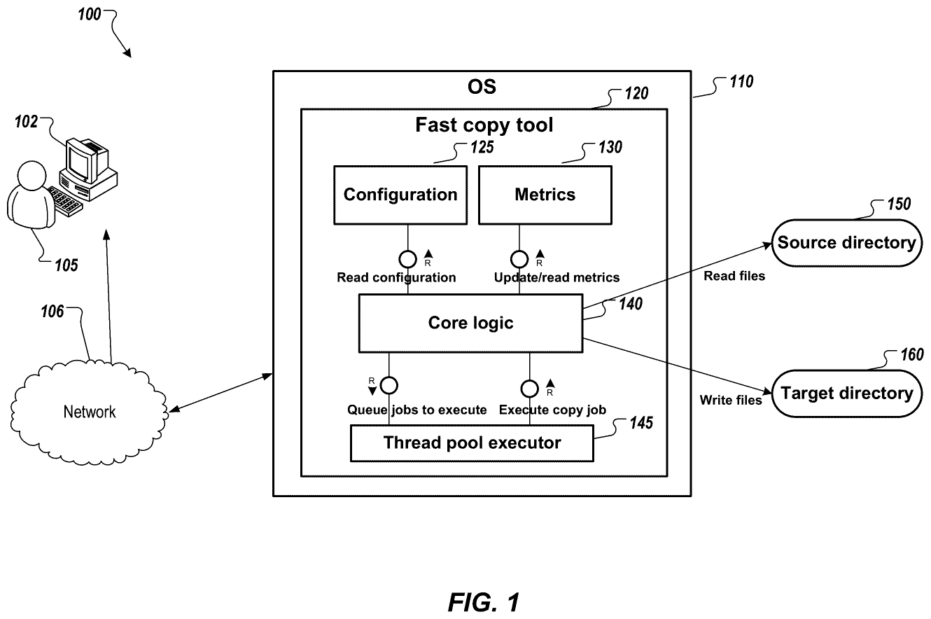

FIG. 1 depicts an example architecture 100 in accordance with implementations of the present disclosure. In the depicted example, the example architecture 100 includes a client device 102, a network 106, and a host infrastructure 110. The host infrastructure 110 includes one or more server devices and databases (e.g., processors, memory). In the depicted example, a user 105 interacts with the client device 102.

In some examples, the client device 102 can communicate with the host infrastructure 110 over the network 106. The client device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a computer network, such as a local area network (LAN), a wide area network (WAN), the Internet, a cellular network, a telephone network (e.g., PSTN), or any appropriate combination thereof connecting any number of communication devices, mobile computing devices, fixed computing devices and server systems.

In some implementations, the host infrastructure 110 includes at least one server and at least one data store. In the example of FIG. 1, the host infrastructure 110 is intended to represent various forms of servers including, but not limited to, a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the host infrastructure 110 can run an application or service on an operating system provided by the host infrastructure. The application or service can be a fast copy tool 120 for executing a copy operation of data from a source directory 150 to a target directory 160 based on a multiple thread execution, as previously discussed and in accordance with implementations of the present disclosure.

In some instances, the fast copy tool 120 can run as a console application on the operating system and can include a configuration 125 that accepts configuration parameters that specify the multi-tread copy job executions. In some instances, the configuration 125 can include parameters such as:
threads—specifying the number of threads to be used for a copy operation from a source directory to a target directory.
overwrite—a Boolean parameter that specifies whether a file to be scheduled for a copy operation is an already existing file that can be determined to be the same (e.g., based on a check rule associated with attributes of the file such as “last modified” as a time stamp of a latest modification, “checksum” uniquely identifying the content of the file, and/or a size attribute, among other example attributes that can be used for the determination).
autotune—a Boolean parameter that specifies whether the tool 120 should perform automatic tuning, where possible, to automatically adjust the number of used threads for the copy operation. This is a parameter that can activate or deactivate the auto-tuning capabilities of the fast copy tool 120;
sourceFolder—the source folder to be copied; and
targetFolder—the target folder where the source folder shall be copied.

In some instances, the fast copy tool 120 can include performance metrics (metrics 130) that are calculated (e.g., periodically, upon request, based on a trigger criterion, or according to a schedule scheme for measurement, among other examples), and can be maintained and used for performing the auto-tuning logic as previously described. The metrics 130 that are maintained at the fast copy tool 120 can be metrics calculated within the fast copy tool or at an external entity that obtains data for the performance of the copy operation. In some instances, the metrics 130 may combine both internally—and externally-generated metrics. The Metrics 130 can include various metrics that can include one or more of the below listed metrics:
totalProcessedFiles—the total number of processed files;
totalProcessedDirectories—the total number of processed directories;
totalProcessedBytes—the total number of processed/copied bytes;
runningThreads—the number of active treads that perform copy operations;
bytesPerSecond—the average bytes per second speed of the copy operation; and/or
filesPerSecond—the average files per second speed of the processed files and directories.

The core logic 140 of the fast copy tool 120 is implemented to obtain an instruction for executing a copy operation of the source directory. In response to obtaining the instruction (e.g., as a request for an external application or triggered by a user), the core logic 140 is configured to generate a list of the files and directories in the source directory. The core logic 140 is configured to process the files and generate copy jobs for those that are to be replicated (e.g., all of the files or some of them, for example, based on evaluating attributes of the files as discussed above). Each file or directory can be scheduled for executing a respective copy job at a thread pool executor 145 in case there are free threads available. For example, the check whether there are free treads available can be performed by reading a metric about the number of running threads from the metrics 130 (if such a metric is maintained at the metrics 130, e.g., the runningThreads metric), the number can be dynamically determined (e.g., by querying the thread pool executor), or the number can be obtained otherwise as a direct input. In cases where there are no free threads to be used at the thread pool executor 145 for a new copy job for a given file and/or directory, a current thread performing a copy operation can be scheduled to directly perform the new copy job on the current file or directory object in the list. This reuse of an active thread to continue working on a next copy job can save and reduce processing resources and time associated with context thread switching. If a new thread is to be open, a new job would be created for the copying of the next file or directory; however, if threads are reused by nesting jobs, the performance of the copy operation of the source directory (e.g., reduce the resources used and execute it faster) to the target directory can be generally improved as there will be lower overhead associated with creating new copy jobs for every single file or entity in the source directory.

In some cases, if the copy job is associated with a directory to be copied, the directory is processed to determine included files in a recursive manner, where the processing of each file within the directory of the source directory 150 can be performed (e.g., in a substantially similar manner as described above).

In some instances, when a request for a copy operation is received, the core logic 140 can include a check to determine whether auto-tuning of the performance has to be applied, for example, by determining the configuration of the auto-tune parameter value at configuration 125. If the execution of the copy operation includes auto-tuning, the auto-tuning can be configured to be executed at regular intervals (e.g., every 10 seconds), in response to particular events or actions, or according to another scheduled pattern for evaluating the performance and adjusting the number of threads. In some instances, the fast copy tool 120 can check how the performance metrics, for example, the bytes per second and/or files per second, have changed in the last 10 seconds. If one or all of the metrics checked has the same or better results than a previous measurement interval(s), then the core logic 140 may be notified to increase the number of copy threads that would run at the thread pool executor 145. In some cases, if the performance metrics show results that are below the measurements from previous interval(s), the core logic 140 may be notified to reduce the number of threads at the thread pool executor 145. The reduction can be to avoid downtime, as the poorer metrics may indicate that the host infrastructure 110, may be overloaded or stressing from the current thread count, such as from system or disk overload.

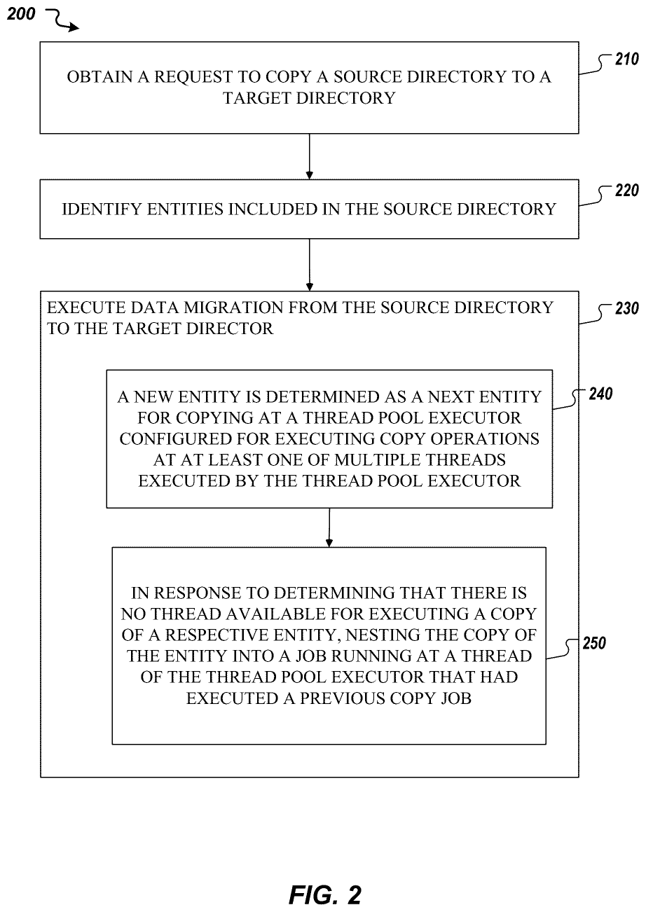

FIG. 2 is a flowchart for an example method 200 for executing data migration between a source directory and a target directory in accordance with implementations of the present disclosure.

The example method 200 may be executed based on a request received from an application or a user to migrate data between directories. The example method 200 may be executed at a tool such as the fast copy tool 120 of FIG. 1 that performs copy operations in parallel threads provided from a thread pool. In some instances, the execution of method 200 may include operations performed by the core logic 140 of the fast copy tool 120 as described in relation to FIG. 1, as well as other suitable components and/or instructions. The application may be similar to the application discussed in relation to FIG. 1.

At 210, a request to copy a source directory to a target directory is obtained. The source and the target directories can be the same or substantially the same as the source directory 150 and the target directory 160 of FIG. 1. The request for the copy can be received at a tool providing copying services, such as the fast copy tool 120 of FIG. 1. The request for copying can also include one or more of the configuration parameters to configure the execution of copying that may define, for example, whether or not to apply auto-tuning for the execution, whether to apply a copy evaluation rule to determine whether all or only some of the files and/or directories from the source directory are to be migrated to the target directory (e.g., as a full copy, a delta copy, or a filtered copy, among other examples), and/or any other suitable parameters.

At 220, entities included in the source directory are identified. This identification includes determining files and directories that can be part of the source directory. Based on the identification, a list of the files and directories of the source directory can be generated and used for evaluation of each entity by the tool to process and schedule a copy job. In some implementations, when an entity in the list is a directory, the files within the directory can be processed recursively, and in some cases all files from the directory can be processed through that thread, and other files from the list can be processed in parallel by other thread(s), as there is no need to wait for the directory to be fully copied to proceed with processing the next file entity in the list.

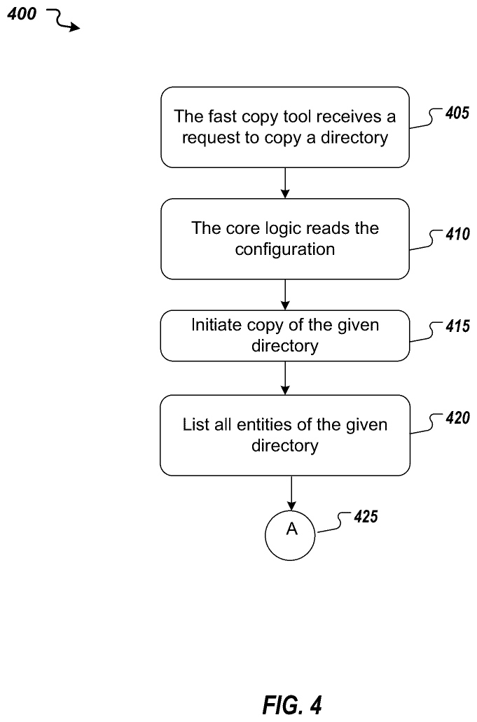

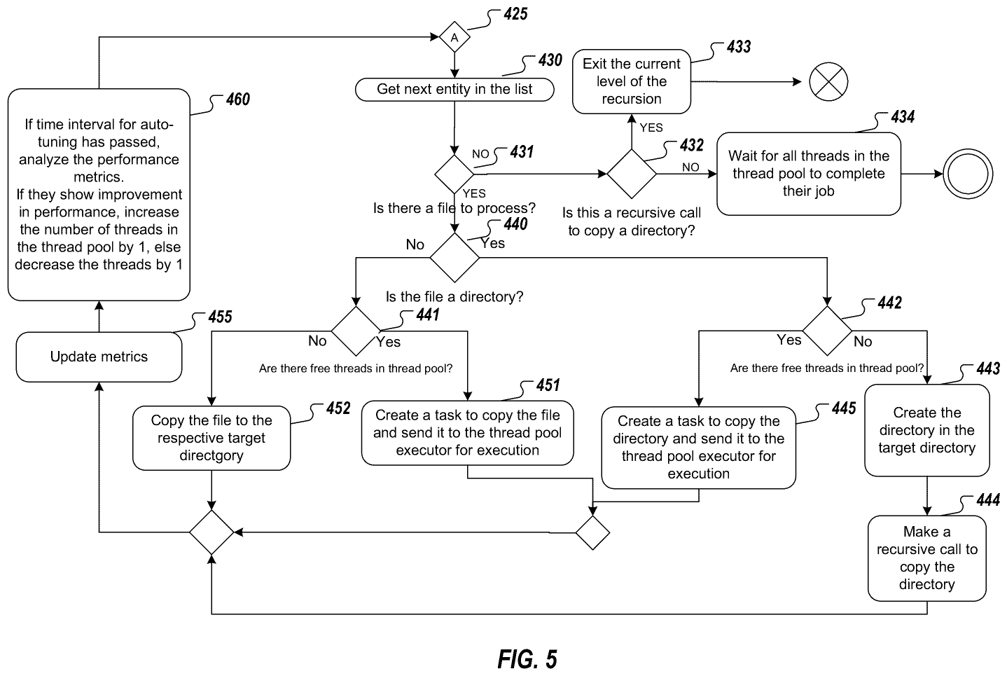

In some instances, when a directory is recursively processed and if there is no available free thread to handle the copying of a next file of the directory, the copying of the file would be executed at a currently running thread. However, in the context of the recursive processing of the directory to make the copy of the directory and in cases where a subsequent created task for copying another file of the directory is processed for scheduling, the subsequent task can be executed at an available thread, if such a thread had been freed, or if there are no more available threads, the task would be executed by the currently processing thread. The recursive processing of directories within the source directory is discussed in more detail in relation to FIGS. 4 and 5. The recursive processing for a directory includes recursively processing multiple files until the directory is exhaustively processed, however, the processing of other files in the initial list of files can continue to be processed by other thread(s) if such are available.

At 230, data migration is executed from the source directory to the target directory by performing the operations 240 and 250. At 240, a new entity can be determined as a next entity for copying at a thread pool executor that is configured to execute copy operations at at least one of multiple threads executed by the thread pool executor. In some instances, the thread pool executor is substantially similar to the thread pool executor 145 of FIG. 1. In some instances, the respective copy job is to be executed for migrating content of the respective entity (e.g., file or directory) from the source directory to the target directory. In some instances, when a copy job is to be created for a directory, a list of the files within the directory is created and recursively processed and the files are copied while reusing existing open threads when there are no further available threads.

At 250, in response to determining that there is no available-for-execution thread for executing the new entity, a respective new copy job for the new entity can be nested for execution to a thread of the thread pool executor that is currently executing a current copy job at the thread pool executor. In some instances, the determination that there is no available-for-execution thread can be made by a thread of the thread pool that finishes a current copy job and is still running. The thread can check if there are more entities to copy, and further, checks if there are free threads to process more job. If there are free threads, a new copy job can be created and scheduled at the thread pool executor. If there are no free threads, the currently executing thread can continue by nesting the new copy job for copying the next entity in the thread without the need to schedule a copy tasks. That respective new copy job can be for a file that is a direct entity determined from the source directory or for a file that is found within a directory within the source directory and in the context of recursive processing of those files within the included directory. In some instances, in response to determining, by the currently executing thread at the thread pool executor, that there is an available-for-execution thread at the thread pool executor, the next scheduled copy job to copy an identified entity is assigned for execution at the available-for-execution thread at the thread pool executor.

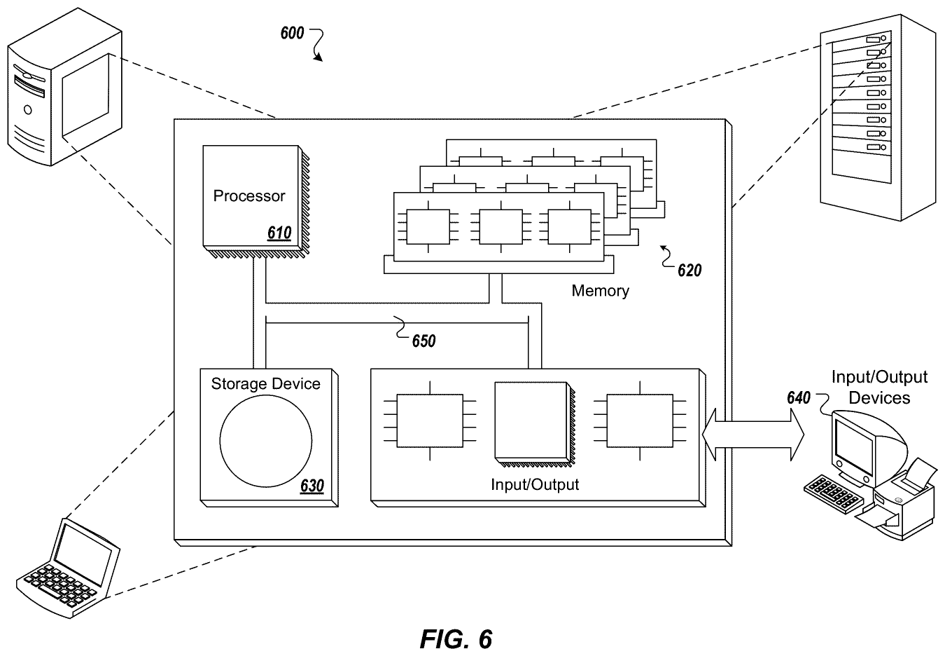

In some instances, processing of files, creating jobs, and assigning jobs to threads in accordance with implementations of the present disclosure is further discussed in relation to FIG. 6.

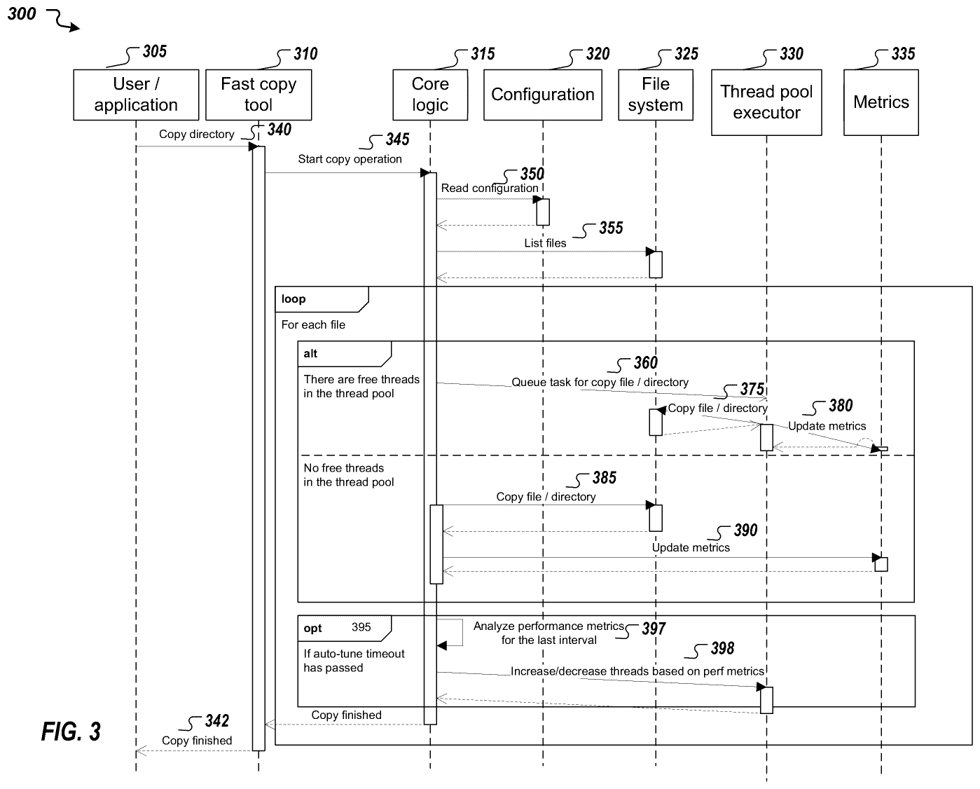

FIG. 3 is a block diagram for an example method 300 for data migration between a source directory and a target directory in accordance with implementations of the present disclosure. In some instances, the example method 300 can be executed in the context of executing a copy operation as described in relation to FIG. 1 and the fast copy tool 310. The method 300 is defined for data migration from a source directory to a target directory, where both directories can be separate data volumes of a file systems 325.

A fast copy tool 310 (that can be substantially similar to the fast copy tool 120 of FIG. 1) receives a copy request for copying a source directory, as a copy directory 340 request. The copy directory 340 request can be substantially similar to the request received at 210 of FIG. 2.

The fast copy tool 310 is configured to start a copy operation 345 for the source directory. The request to start the copy operation 345 can be based on a request from a user or application 305 that is received at or by the fast copy tool 310. The fast copy tool 310 includes core logic 315, configuration 320, metrics 335, and a thread pool executor 330 that may, in some implementations, substantially correspond to the core logic 140, the configuration 125, the metrics 130, and the thread pool executor 145 of FIG. 1.

The core logic 315 of the fast copy tool 310 executes an algorithm to obtain information about the parameters for the copy operation 345. The core logic 315 reads the configuration as configuration parameters from the configuration 320 (at 350) and uses those parameters to determine requirements for executing the copy operation 345. For example, the configuration can define whether auto-tuning (as shown at 395) has to be executed during the copy operation 345. The core logic 315 obtains a list (at 355) of the files and directories of the source directory from the file system 325. The core logic 315 is implemented to include operations that correspond at least partially to the operations 220, 230, 240, and 250 of FIG. 2.

At 360, for each file of the list 355 of files and directories, the core logic 315 includes logic to determine when and how to process an entity that is to be copied through a thread from the pool. The thread pool executor 330 can run a thread to copy a respective file. In some instances, when there are available free threads in the thread pool, the thread used for executing the copy would be a free thread from the thread pool provided by the thread pool executor 330 (at 375). If, however, there are no free threads in the thread pool, an existing thread currently finishing the execution of a current job, can check whether there are more entities to be copied, and, if there are no free threads, the running thread would copy the entity as a nested task so that the current thread can be assigned (at 385) to copy the file at the target directory at the file system 325.

In some instances, upon completion of the execution of the copy of the entity, either by a new thread or by reusing an open thread that had finished executing another copy operation of a file or directory and the nested copy, the thread can update the metrics for the performance of the copy executions at the metrics 335 module. The update of the metrics can be performed by the copy task that is executed, as shown at 380. The update can be performed when the copy of the entity is finished. The update of the metrics can be performed by the core logic 315, when the execution of the job is done by reusing an open currently working thread, as shown at 390. In some instances, and not shown on the figure, the update of the metrics at 380 and 390 may not be performed, if the read configuration 350 does not identify that auto-tuning should be configured for the copy operation. In some instances, the updates at 380 and 390 may be performed even if the auto-tuning is not configured for the particular copy operation. The stored metrics at the metrics 335 can be used for the auto-tuning of the number of threads to improve the performance, but also may be used to derive insight into thread execution and be used for adjusting the hardware or software infrastructure associated with the fast copy tool 310 (e.g., provide more hardware or software resources to support faster execution).

In cases where the read configuration 350 indicates that auto-tuning is to be performed, the performance metric for the performance for a set period (e.g., of time) can be invoked from the metric 335 and be analyzed at 397 to determine whether to adjust the number of threads that are available for use by the thread pool executor. For example, at 398, it can be determined, based on the analysis at 397, that an adjustment to the thread number is to be made to improve the performance (e.g., increase or decrease the thread number). The determination for the adjustment can be provided as a result of the analysis of the performance at 397. The analysis of the performance 397 can be configured to be performed based on adjustment criteria as previously discussed in the disclosure and related to FIGS. 1, 2, and 3.

When the core logic 315 processes all the files and directories (where files in the directory are recursively processed in a similar manner as the files directly included in the source directory) from the list, the fast copy tool 310 may acknowledge the copy execution as completed and can send a notification (at 342) to the requesting user or application 305 for the result of the copy operation.

FIGS. 4 and 5 are flowcharts for an example method 400 for data migration between a source directory and a target directory in accordance with implementations of the present disclosure. The execution of the example method 400 can be performed at a fast copy tool as discussed throughout the present disclosure and for example can be substantially similar to at least portions of the described method for data migration at FIGS. 1, 2, and 3. The fast copy tool that can execute the example method 400 can be substantially similar to the fast copy tool 120 of FIGS. 1 and 310 of FIG. 3.

FIG. 5 shows a portion of the method 400 that is associated with iterative processing of listed entities in the list as determined at the operation 420 shown on FIG. 4. As such, the process of FIG. 5 is executed in response to determining the list of entities at the end of the operations shown at FIG. 4.

At 405, the fast copy tool can receive a request to copy a source directory. At 410, the core logic of the fast copy tool reads the configuration defined for the copy operation (e.g., a particular configuration set up for the requested copy or a default one defined at the fast copy tool, e.g., based on user or application input). At 415, a copy operation for the source directory that is to be copied is initiated. At 420, a list of entities of the source directory is determined. The list of entities is provided at 425 for iterative processing over each one of the entities as shown at FIG. 5.

Entities are taken individually from the provided list at 430 of FIG. 5. At 431, a determination is made as to whether the current entity is a file that needs to be processed. If there is no file to process, a determination is made at 432 whether the entity that is processed at 431 is associated with a recursive call to process files from a directory as the entity in the source directory. If there is no file for processing and the obtained entity is within a recursive call for copying files from a directory, then, at 433, the recursion for the directory can be finalized and method 400 can exit from that directory processing and continue to the next entity in the list, returning to 430. If at 432, a determination is made that the entity is not within a recursive call for a directory, then, at 434, method 400 proceeds so that all threads in the thread pool complete their scheduled jobs and the copy operation is successfully executed.

If at 431, a determination is made that there is a file to be processed, then, at 440, a determination is made as to whether the file entity is a directory. A file entity can be a file or a directory. If the file entity is a directory, at 442, a determination is made as to whether there are free threads in the thread pool. If at 442, it is determined that there are free threads in the thread pool, then, at 445, a task is created to copy the directory and to send the task to the thread pool executor for execution (e.g., the files from the directory would be processed by assigning copy jobs to threads by the thread pool executor as described).

In response to creating the task at 445, metrics for performance of the tasks are updated at 455. Then, at 460, if the time interval defined for evaluating whether to adjust the number of threads (i.e., the auto-tuning) has passed, the performance metrics can be evaluated. If those performance metrics indicate an improvement of the performance, an increase of the number of threads in the thread pool can be performed, for example, by one or another number of threads that can be dynamically configured or obtained as a default number. If the performance has decreased, then at 460 a determination can be made to decrease the number of threads (e.g., by one or more numbers of threads, which may or may not correspond to the number of threads defined for an increase had the performance improved). After performance of the auto-tuning at 460, the next entity from the list is obtained from 425.

If, at 442, it is determined that there are no free threads in the thread pool, then, the copy directory operation will be executed in the current thread. At 443, the directory is created in the target directory. Once the directory is created in the target directory, a recursive call is made to initiate a copy of the files within the directory (so that the files within the directory are processed in a similar way as the entities as determined at 415). At 444, a recursive call is made to initiate a copy operation to copy files of the directory to the corresponding directory as created at 443 in the target directory. The recursive call returns to 425, where in addition to the executing the recursive call for the files in the directory, the metrics are updated at 455, as well as auto-tuning is performed as described at 460, as shown on FIG. 5.

If at 440, it is determined that there is a file to process and the file is not a directory, then, at 441, a determination is made as to whether there are free threads in the thread pool. If there are free treads in the thread pool, a task is created at 451 to copy the file into the target directory and to send the task to the thread pool executor for execution. Upon execution of the task, performance metrics can be updated at 455, and auto-tuning for adjusting the number of available threads can be performed at 460. Once completed, the next entity from the list is invoked at 425. If, however, it is determined at 441 that there are no more free threads available in the thread pool (i.e., all defined threads are occupied with current execution of tasks), at 452, the execution of the copy operation for the file is performed in the current thread. In those cases, the execution of the copy of the file is nested into the current thread, and the thread is reused. When the copy operation at 452 is executed, metrics can be updated at 455 and auto-tuning at 460 can be performed.

By utilizing a fast copy tool as described in FIGS. 1, 2, 3, 4, and 5, performance of the copy operation is improved as the speed of copying can be substantially increased while also reducing any potential downtime for an application or service that relies on access to data from the source directory. In some implementations, the execution of the copy logic as described can be performed with different numbers of threads defined at the thread pool, where the initial number of threads to be used can be defined based on input data or based on analysis of data from historically executed copy operations and performance evaluations for example, over test infrastructure with particular hardware and software resource characteristics (e.g., one or more of aa particular setup of an operation system, a set of CPU cores, particular RAM, and type of disk storage).

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device, such as a CRT (cathode ray tube) or LCD (liquid crystal display) monitor for displaying information to the user and a keyboard and a pointing device, such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication, such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

### EXAMPLES

Although the present application is defined in the attached claims, it should be understood that the present invention can also (alternatively) defined in accordance with the following examples:

Example 1: A computer-implemented method, the method comprising:
obtaining a request to copy a source directory to a target directory;
identifying entities included in the source directory; and
executing data migration from the source directory to the target directory by performing, for each identified entity:
   assigning a thread pool executor that is configured to execute copy operations at at least one of multiple threads executed by the thread pool executor, wherein a new copy job is to be executed for migrating content of a respective entity from the source directory to the target directory; and
   in response to determining that there is no available-for-execution thread at the thread pool executor, copying the respective entity as a nested copy in a currently executing thread that is executing a current copy job.

Example 2. The method of Example 1, wherein the entities include a first set of files and a second set of directories.

Example 3. The method of any one of the preceding Examples, wherein for each identified entity, the method comprises:
in response to determining, by the currently executing thread at the thread pool executor, that there is an available-for-execution thread at the thread pool executor, providing a new scheduled copy job to copy the respective entity through the available-for-execution thread at the thread pool executor.

Example 4. The method of any one of the preceding Examples, wherein the request to copy is received from an application that requests execution of the data migration of data from the source directory to the target directory, wherein during the data migration, the application is denied write access to data from at least one of the source directory or the target directory for processing service requests received at the application.

Example 5. The method of any one of the preceding Examples, wherein the thread pool executor is configured to include a plurality of threads for parallel job execution, wherein a number of the plurality of threads is adjustable during the data migration execution based on thread optimization rules.

Example 6. The method of any one of the preceding Examples, the method comprising:
in response to performing scheduled checks of performance of the data migration, determining a performance score at each scheduled check defining a number of executed copy operations with a predefined time period; and
in response to determining a change in the performance score over a threshold time for executing the scheduled checks, auto-tuning a number of threads allocated for parallel processing at the thread pool executor.

Example 7. The method of any one of the preceding Examples, wherein the determination that there is no available-for-execution thread is performed by the currently executing thread upon finishing of the current copy job and while the current executing thread is running.

What is claimed is:

1. A computer-implemented method comprising:
obtaining a request to copy a source directory to a target directory;
identifying entities included in the source directory; and
executing data migration from the source directory to the target directory by performing, for each identified entity:
assigning a thread pool executor that is configured to execute copy operations at at least one of multiple threads executed by the thread pool executor, wherein a new copy job is to be executed for migrating content of a respective entity from the source directory to the target directory; and
in response to determining that there is no available-for-execution thread at the thread pool executor, copying the respective entity as a nested copy in a currently executing thread that is executing a current copy job.

2. The method of claim 1, wherein the entities include a first set of files and a second set of directories.

3. The method of claim 1, wherein for each identified entity, the method comprises:
in response to determining, by the currently executing thread at the thread pool executor, that there is an available-for-execution thread at the thread pool executor, providing a new scheduled copy job to copy the respective entity through the available-for-execution thread at the thread pool executor.

4. The method of claim 1, wherein the request to copy is received from an application that requests execution of the data migration of data from the source directory to the target directory, wherein during the data migration, the application is denied write access to data from at least one of the source directory or the target directory for processing service requests received at the application.

5. The method of claim 1, wherein the thread pool executor is configured to include a plurality of threads for parallel job execution, wherein a number of the plurality of threads is adjustable during the data migration execution based on thread optimization rules.

6. The method of claim 1, the method comprising:
in response to performing scheduled checks of performance of the data migration, determining a performance score at each scheduled check defining a number of executed copy operations with a predefined time period; and
in response to determining a change in the performance score over a threshold time for executing the scheduled checks, auto-tuning a number of threads allocated for parallel processing at the thread pool executor.

7. The method of claim 1, wherein the determination that there is no available-for-execution thread is performed by the currently executing thread upon finishing of the current copy job and while the current executing thread is running.

8. A non-transitory, computer-readable medium coupled to one or more processors and having instructions stored thereon which, when executed by the one or more processors, cause the one or more processors to perform operations, the operations comprising:
obtaining a request to copy a source directory to a target directory;
identifying entities included in the source directory; and
executing data migration from the source directory to the target directory by performing, for each identified entity:
assigning a thread pool executor that is configured to execute copy operations at at least one of multiple threads executed by the thread pool executor, wherein a new copy job is to be executed for migrating content of a respective entity from the source directory to the target directory; and
in response to determining that there is no available-for-execution thread at the thread pool executor, copying the respective entity as a nested copy in a currently executing thread that is executing a current copy job.

9. The non-transitory, computer-readable medium of claim 8, wherein the entities include a first set of files and a second set of directories.

10. The non-transitory, computer-readable medium of claim 8, wherein for each identified entity, the operations comprise:
in response to determining, by the currently executing thread at the thread pool executor, that there is an available-for-execution thread at the thread pool executor, providing a new scheduled copy job to copy the respective entity through the available-for-execution thread at the thread pool executor.

11. The non-transitory, computer-readable medium of claim 8, wherein the request to copy is received from an application that requests execution of the data migration of data from the source directory to the target directory, wherein during the data migration, the application is denied write access to data from at least one of the source directory or the target directory for processing service requests received at the application.

12. The non-transitory, computer-readable medium of claim 8, wherein the thread pool executor is configured to include a plurality of threads for parallel job execution, wherein a number of the plurality of threads is adjustable during the data migration execution based on thread optimization rules.

13. The non-transitory, computer-readable medium of claim 8, wherein the operations further comprise:
in response to performing scheduled checks of performance of the data migration, determining a performance score at each scheduled check defining a number of executed copy operations with a predefined time period; and
in response to determining a change in the performance score over a threshold time for executing the scheduled checks, auto-tuning a number of threads allocated for parallel processing at the thread pool executor.

14. A system comprising
a computing device; and
a computer-readable storage device coupled to the computing device and having instructions stored thereon which, when executed by the computing device, cause the computing device to perform operations, the operations comprising:
obtaining a request to copy a source directory to a target directory;
identifying entities included in the source directory; and
executing data migration from the source directory to the target directory by performing, for each identified entity:
assigning a thread pool executor that is configured to execute copy operations at at least one of multiple threads executed by the thread pool executor, wherein a new copy job is to be executed for migrating content of a respective entity from the source directory to the target directory; and
in response to determining that there is no available-for-execution thread at the thread pool executor, copying the respective entity as a nested copy in a currently executing thread that is executing a current copy job.

15. The system of claim 14, wherein the entities include a first set of files and a second set of directories.

16. The system of claim 14, wherein for each identified entity, the computer-readable storage device stores further instructions which, when executed by the computing device, cause the computing device to perform operations, the operations comprising:
in response to determining, by the currently executing thread at the thread pool executor, that there is an available-for-execution thread at the thread pool executor, providing a new scheduled copy job to copy the respective entity through the available-for-execution thread at the thread pool executor.

17. The system of claim 14, wherein the request to copy is received from an application that requests execution of the data migration of data from the source directory to the target directory, wherein during the data migration, the application is denied write access to data from at least one of the source directory or the target directory for processing service requests received at the application.

18. The system of claim 14, wherein the thread pool executor is configured to include a plurality of threads for parallel job execution, wherein a number of the plurality of threads is adjustable during the data migration execution based on thread optimization rules.

19. The system of claim 14, wherein the computer-readable storage device further stores instructions which, when executed by the computing device, cause the computing device to perform operations comprising:
in response to performing scheduled checks of performance of the data migration, determining a performance score at each scheduled check defining a number of executed copy operations with a predefined time period; and
in response to determining a change in the performance score over a threshold time for executing the scheduled checks, auto-tuning a number of threads allocated for parallel processing at the thread pool executor.

20. The system of claim 14, wherein the determination that there is no available-for-execution thread is performed by the currently executing thread upon finishing of the current copy job and while the current executing thread is running.
